(19) United States
(12) Patent Application Publication
(10) Pub. No.: US 2025/0097783 A1
(43) Pub. Date: Mar. 20, 2025

(54) APPARATUS, METHODS AND COMPUTER PROGRAMS SUPPORTING MACHINE LEARNING FUNCTIONALITY

(71) Applicant: Nokia Technologies Oy, Espoo (FI)

(72) Inventors: Muhammad Majid BUTT, Naperville, IL (US); Amaanat ALI, Espoo (FI); Endrit DOSTI, Espoo (FI); István Zsolt KOVÁCS, Aalborg (DK)

(21) Appl. No.: 18/882,627

(22) Filed: Sep. 11, 2024

(30) Foreign Application Priority Data
Sep. 20, 2023 (FI) 20236036

(51) Int. Cl. H04W 36/00; H04W 72/1268; H04W 76/20

(52) U.S. Cl. CPC H04W 36/0058; H04W 72/1268; H04W 76/20

(57) ABSTRACT

An apparatus comprising: means for receiving configuration from a first node, the configuration relating to collection of training data during a handover of the apparatus from the first node to a second node; means for controlling collection of training data from measurements during the handover based on the configuration; means for informing the second node a state of the collection of the training data from the measurements following a completion of the handover; and means for transferring any collection of the training data from the measurements to the second node following the completion of the handover.

### FIELD

This disclosure relates to apparatus, methods and computer programs and in particular but not exclusively to apparatus, methods and computer programs relating to apparatus, methods and computer programs supporting machine learning functionality.

### BACKGROUND

A communication system can be seen as a facility that enables communications between two or more communication devices, or provides communication devices access to a data network.

A communication system may be a wireless communication system. Examples of wireless communication systems comprise public land mobile networks (PLMN) operating based on radio access technology standards such as those provided by 3GPP (Third Generation Partnership Project) or ETSI (European Telecommunications Standards Institute), satellite communication systems and different wireless local networks, for example wireless local area networks (WLAN). Wireless communication systems operating based on a radio access technology can typically be divided into cells and are therefore often referred to as cellular systems.

A communication system and associated devices typically operate in accordance with one or more radio access technologies defined in a given specification of a standard, such as the standards provided by 3GPP or ETSI, which sets out what the various entities associated with the communication system and the communication devices accessing or connecting to the communication system are permitted to do and how that should be achieved. Communication protocols and/or parameters which shall be used by communication devices for accessing or connecting to a communication system are also typically defined in standards. Examples of a standard are the so-called 5G (5^{th} Generation) standards provided by 3GPP.

### SUMMARY

According to an aspect, there is provided an apparatus comprising: means for receiving configuration from a first node, the configuration relating to collection of training data during a handover of the apparatus from the first node to a second node; means for controlling collection of training data from measurements during the handover based on the configuration; means for informing the second node a state of the collection of the training data from the measurements following a completion of the handover; and means for transferring any collection of the training data from the measurements to the second node following the completion of the handover.

The means for controlling the collection of the training data from the measurements based on the configuration during the handover may comprise at least one of: suspending a normal collection of the training data following an initiation of the handover; switching the collection of the training data to a separate training data buffer following the initiation of the handover; separating the collection of the training data into a normal data buffer and a handover training data buffer following the initiation of the handover; resuming the normal collection of the training data following a successful handover; and returning the collection of the training data collection to an earlier training data buffer following the successful handover.

The means for controlling the collection of the training data from the measurements during the handover based on the configuration may be for evaluating received configuration conditions and control the collection of the training data from the measurements based on the evaluation.

The apparatus may further comprise means for receiving a radio resource control reconfiguration message from the first node, wherein the radio resource control reconfiguration message comprises training data collection configuration for controlling the collection of the training data from the measurements, the training data collection configuration generated based on an evaluation, performed at the first node, of network conditions between the apparatus and the first node.

The means for informing the second node the state of the collection of the training data from the measurements following a completion of the handover may comprise informing the second node that the collection of the training data from the measurements comprises at least two separate training data buffers and information for assisting the processing of the at least two separate training data buffers.

The apparatus may further comprise means for sending a measurement report to the first node, wherein the measurement report comprises a collection of training data update early indication.

The apparatus may further comprise means for sending a radio resource control reconfiguration complete message to the first node, wherein the radio resource control reconfiguration complete message comprises a collection of training data update indication.

The apparatus may further comprise means for receiving a training data dispatch request from the second node, wherein the training data dispatch request comprises an uplink grant configuration.

The means for transferring any collection of the training data from the measurements to the second node following the completion of the handover may be for sending a training data dispatch using the uplink grant configuration, the training data dispatch comprising at least one collection of training data buffer with assistance information.

The apparatus may be a user equipment, wherein the first node may be a source node and the second node may be a target node for the handover.

According to a second aspect there is provided an apparatus comprising: means for generating configuration for at least one user equipment, the configuration relating to collection of training data associated with a handover of the user equipment involving the apparatus when operating as a first node to a second node; means for receiving information identifying a state of the collection of the training data from measurements following a completion of the handover; and means for receiving any collection of the training data from the measurements from the user equipment following the completion of the handover.

The means for generating configuration relating to the collection of the training data associated with the handover may be for controlling the collection of the training data from the measurements to perform at least one of: suspending a normal collection of the training data following an initiation of the handover; switching the collection of the training data to a separate training data buffer following the initiation of the handover; separating the collection of the training data into a normal training data buffer and a handover training data buffer following the initiation of the handover; resuming the normal collection of the training data following a successful handover; and returning the collection of the training data to an earlier training data buffer following the successful handover.

The configuration relating to the collection of the training data may comprise at least one network condition between the apparatus and the user equipment, wherein the at least one network condition is evaluated within the user equipment and based on the evaluation the user equipment is configured to control the collection of the training data from the measurements.

The apparatus may further comprise: means for evaluating network conditions between the apparatus and the user equipment; and means for sending to the user equipment an indicator for controlling the collection of the training data from the measurements at the user equipment based on the evaluation of the network conditions between the apparatus and the user equipment.

The means for receiving information identifying the state of the collection of the training data from the measurements following the completion of the handover may be for receiving information from the second node that the collection of the training data from the measurements comprises at least two separate training data buffers and information for assisting the processing of the at least two separate training data buffers.

The means for receiving any collection of the training data from the measurements from the user equipment following the completion of the handover further may be means for receiving at least one data collection buffer with assistance information, the assistance information for assisting the processing of the at least one data collection buffer.

The apparatus may further comprise means for receiving a measurement report from the user equipment, wherein the measurement report comprises a collection of training data update early indication for controlling a generation of configuration information.

The apparatus may further comprise means for receiving a radio resource control reconfiguration complete message from the user equipment, wherein the radio resource control reconfiguration complete message comprises a collection of training data update indication.

The means for receiving the information identifying the state of the collection of the training data from measurements following the completion of the handover may be for receiving information from the user equipment that the collection of the training data from the measurements comprises at least two separate training data buffers and information for assisting the processing of the at least two separate training data buffers.

The means for receiving any collection of the training data from the measurements from the user equipment following the completion of the handover further may be for receiving at least one collection of training data buffer with assistance information.

The apparatus may further comprise means for transmitting a training data dispatch request to the user equipment, wherein the training data dispatch request comprises an uplink grant configuration, and the means for receiving any collection of the training data from the measurements from the user equipment following the completion of the handover further comprises means for receiving a training data dispatch using the uplink grant configuration, the training data dispatch comprising the at least one collection of training data buffer with assistance information.

The collection of the training data from the measurements may be for a machine learning model. According to a third aspect, there is provided a method, for an apparatus, the method comprising: receiving configuration from a first node, the configuration relating to collection of training data during a handover of the apparatus from the first node to a second node; controlling collection of training data from measurements during the handover based on the configuration; informing the second node a state of the collection of the training data from the measurements following a completion of the handover; and transferring any collection of the training data from the measurements to the second node following the completion of the handover.

Controlling the collection of the training data from the measurements based on the configuration during the handover may comprise at least one of: suspending a normal collection of the training data following an initiation of the handover; switching the collection of the training data to a separate training data buffer following the initiation of the handover; separating the collection of the training data into a normal data buffer and a handover training data buffer following the initiation of the handover; resuming the normal collection of the training data following a successful handover; and returning the collection of the training data collection to an earlier training data buffer following the successful handover.

Controlling the collection of the training data from the measurements during the handover based on the configuration may comprise evaluating received configuration conditions and control the collection of the training data from the measurements based on the evaluation.

The method may further comprise receiving a radio resource control reconfiguration message from the first node, wherein the radio resource control reconfiguration message comprises training data collection configuration for controlling the collection of the training data from the measurements, the training data collection configuration generated based on an evaluation, performed at the first node, of network conditions between the apparatus and the first node.

Informing the second node the state of the collection of the training data from the measurements following a completion of the handover may comprise informing the second node that the collection of the training data from the measurements comprises at least two separate training data buffers and information for assisting the processing of the at least two separate training data buffers.

The method may further comprise sending a measurement report to the first node, wherein the measurement report comprises a collection of training data update early indication.

The method may further comprise sending a radio resource control reconfiguration complete message to the first node, wherein the radio resource control reconfiguration complete message comprises a collection of training data update indication.

The method may further comprise receiving a training data dispatch request from the second node, wherein the training data dispatch request comprises an uplink grant configuration.

Transferring any collection of the training data from the measurements to the second node following the completion of the handover may be for sending a training data dispatch using the uplink grant configuration, the training data dispatch comprising at least one collection of training data buffer with assistance information.

The apparatus may be a user equipment, wherein the first node may be a source node and the second node may be a target node for the handover.

According to a fourth aspect there is provided a method for a node, the method comprising: generating configuration for at least one user equipment, the configuration relating to collection of training data associated with a handover of the at least one user equipment involving the node; receiving information identifying a state of the collection of training data from measurements following a completion of the handover; and receiving any collection of the training data from the measurements from the at least one user equipment following the completion of the handover.

Generating configuration relating to the collection of the training data associated with the handover may comprise controlling the collection of the training data from the measurements to perform at least one of: suspending a normal collection of the training data following an initiation of the handover; switching the collection of the training data to a separate training data buffer following the initiation of the handover; separating the collection of the training data into a normal training data buffer and a handover training data buffer following the initiation of the handover; resuming the normal collection of the training data following a successful handover; and returning the collection of the training data to an earlier training data buffer following the successful handover.

The configuration relating to the collection of the training data may comprise at least one network condition between the apparatus and the user equipment, wherein the at least one network condition is evaluated within the user equipment and based on the evaluation the user equipment is configured to control the collection of the training data from the measurements.

The method may further comprise: evaluating network conditions between the apparatus and the user equipment; and sending to the user equipment an indicator for controlling the collection of the training data from the measurements at the user equipment based on the evaluation of the network conditions between the apparatus and the user equipment.

Receiving information identifying the state of the collection of the training data from the measurements following the completion of the handover may comprise receiving information from the second node that the collection of the training data from the measurements may comprise at least two separate training data buffers and information for assisting the processing of the at least two separate training data buffers.

Receiving any collection of the training data from the measurements from the user equipment following the completion of the handover further may comprise receiving at least one data collection buffer with assistance information, the assistance information for assisting the processing of the at least one data collection buffer.

The method may further comprise receiving a measurement report from the user equipment, wherein the measurement report comprises a collection of training data update early indication for controlling a generation of configuration information.

The method may further comprise receiving a radio resource control reconfiguration complete message from the user equipment, wherein the radio resource control reconfiguration complete message comprises a collection of training data update indication.

Receiving the information identifying the state of the collection of the training data from measurements following the completion of the handover may comprise receiving information from the user equipment that the collection of the training data from the measurements comprises at least two separate training data buffers and information for assisting the processing of the at least two separate training data buffers.

Receiving any collection of the training data from the measurements from the user equipment following the completion of the handover further may comprise receiving at least one collection of training data buffer with assistance information.

The method may further comprise transmitting a training data dispatch request to the user equipment, wherein the training data dispatch request comprises an uplink grant configuration, and receiving any collection of the training data from the measurements from the user equipment following the completion of the handover further may comprise receiving a training data dispatch using the uplink grant configuration, the training data dispatch comprising the at least one collection of training data buffer with assistance information.

The collection of the training data from the measurements may be for a machine learning model.

According to a fifth aspect there is provided an apparatus comprising at least one processor and at least one memory including a computer program code, the at least one memory and the computer program code configured to, with the at least one processor, cause the apparatus at least to perform: receiving configuration from a first node, the configuration relating to collection of training data during a handover of the apparatus from the first node to a second node; controlling collection of training data from measurements during the handover based on the configuration; informing the second node a state of the collection of the training data from the measurements following a completion of the handover; and transferring any collection of the training data from the measurements to the second node following the completion of the handover.

The apparatus caused to perform controlling the collection of the training data from the measurements based on the configuration during the handover may be caused to perform at least one of: suspending a normal collection of the training data following an initiation of the handover; switching the collection of the training data to a separate training data buffer following the initiation of the handover; separating the collection of the training data into a normal data buffer and a handover training data buffer following the initiation of the handover; resuming the normal collection of the training data following a successful handover; and returning the collection of the training data collection to an earlier training data buffer following the successful handover.

The apparatus caused to perform controlling the collection of the training data from the measurements during the handover based on the configuration may be caused to perform evaluating received configuration conditions and control the collection of the training data from the measurements based on the evaluation.

The apparatus may be further caused to perform receiving a radio resource control reconfiguration message from the first node, wherein the radio resource control reconfiguration message comprises training data collection configuration for controlling the collection of the training data from the measurements, the training data collection configuration generated based on an evaluation, performed at the first node, of network conditions between the apparatus and the first node.

The apparatus caused to perform informing the second node the state of the collection of the training data from the measurements following a completion of the handover may be caused to perform informing the second node that the collection of the training data from the measurements comprises at least two separate training data buffers and information for assisting the processing of the at least two separate training data buffers.

The apparatus may be further caused to perform sending a measurement report to the first node, wherein the measurement report comprises a collection of training data update early indication.

The apparatus may be further caused to perform sending a radio resource control reconfiguration complete message to the first node, wherein the radio resource control reconfiguration complete message comprises a collection of training data update indication.

The apparatus may be further caused to perform receiving a training data dispatch request from the second node, wherein the training data dispatch request comprises an uplink grant configuration.

The apparatus caused to perform transferring any collection of the training data from the measurements to the second node following the completion of the handover may be caused to perform sending a training data dispatch using the uplink grant configuration, the training data dispatch comprising at least one collection of training data buffer with assistance information.

The apparatus may be a user equipment, wherein the first node may be a source node and the second node may be a target node for the handover.

According to a sixth aspect there is provided there is provided an apparatus operating as a node within a network, the apparatus comprising at least one processor and at least one memory including a computer program code, the at least one memory and the computer program code configured to, with the at least one processor, cause the apparatus at least to perform: generating configuration for at least one user equipment, the configuration relating to collection of training data associated with a handover of the at least one user equipment involving the node; receiving information identifying a state of the collection of training data from measurements following a completion of the handover; and receiving any collection of the training data from the measurements from the at least one user equipment following the completion of the handover.

The apparatus caused to perform generating configuration relating to the collection of the training data associated with the handover may be caused to perform controlling the collection of the training data from the measurements to perform at least one of: suspending a normal collection of the training data following an initiation of the handover; switching the collection of the training data to a separate training data buffer following the initiation of the handover; separating the collection of the training data into a normal training data buffer and a handover training data buffer following the initiation of the handover; resuming the normal collection of the training data following a successful handover; and returning the collection of the training data to an earlier training data buffer following the successful handover.

The configuration relating to the collection of the training data may comprise at least one network condition between the apparatus and the user equipment, wherein the at least one network condition is evaluated within the user equipment and based on the evaluation the user equipment is configured to control the collection of the training data from the measurements.

The apparatus may be further caused to perform: evaluating network conditions between the apparatus and the user equipment; and sending to the user equipment an indicator for controlling the collection of the training data from the measurements at the user equipment based on the evaluation of the network conditions between the apparatus and the user equipment.

The apparatus caused to perform receiving information identifying the state of the collection of the training data from the measurements following the completion of the handover may be caused to perform receiving information from the second node that the collection of the training data from the measurements comprises at least two separate training data buffers and information for assisting the processing of the at least two separate training data buffers.

The apparatus caused to perform receiving any collection of the training data from the measurements from the user equipment following the completion of the handover further may comprise receiving at least one data collection buffer with assistance information, the assistance information for assisting the processing of the at least one data collection buffer.

The apparatus may be further caused to perform receiving a measurement report from the user equipment, wherein the measurement report comprises a collection of training data update early indication for controlling a generation of configuration information.

The apparatus may be further caused to perform receiving a radio resource control reconfiguration complete message from the user equipment, wherein the radio resource control reconfiguration complete message comprises a collection of training data update indication.

The apparatus caused to perform receiving the information identifying the state of the collection of the training data from measurements following the completion of the handover may be caused to perform receiving information from the user equipment that the collection of the training data from the measurements comprises at least two separate training data buffers and information for assisting the processing of the at least two separate training data buffers.

The apparatus caused to perform receiving any collection of the training data from the measurements from the user equipment following the completion of the handover further may be caused to perform receiving at least one collection of training data buffer with assistance information.

The apparatus may be further caused to perform transmitting a training data dispatch request to the user equipment, wherein the training data dispatch request comprises an uplink grant configuration, and the apparatus caused to perform receiving any collection of the training data from the measurements from the user equipment following the completion of the handover further may be caused to receive a training data dispatch using the uplink grant configuration, the training data dispatch comprising the at least one collection of training data buffer with assistance information.

The collection of the training data from the measurements may be for a machine learning model.

According to a further aspect, there is provided a computer program comprising instructions, which when executed by an apparatus, cause the apparatus to perform any of the methods set out previously.

According to a further aspect, there is provided a computer program comprising instructions, which when executed cause any of the methods set out previously to be performed.

According to an aspect there is provided a computer program comprising computer executable code which when cause any of the methods set out previously to be performed.

According to an aspect, there is provided a computer readable medium comprising program instructions stored thereon for performing at least one of the above methods.

According to an aspect, there is provided a non-transitory computer readable medium comprising program instructions which when executed by an apparatus, cause the apparatus to perform any of the methods set out previously.

According to an aspect, there is provided a non-transitory computer readable medium comprising program instructions which when executed cause any of the methods set out previously to be performed.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

### BRIEF DESCRIPTION OF FIGURES

Some examples will now be described in further detail, by way of illustration only, with reference to the accompanying drawings, in which:

FIG. 1a shows a schematic representation of a 5G system;

FIG. 1b shows a schematic representation of an apparatus;

FIG. 1c shows a schematic representation of a user equipment;

FIGS. 2a and 2b illustrates an example message sequence flow for conditional handover;

FIG. 3 shows some non-limiting example beam management (BM) use cases for AI/ML;

FIG. 4 shows example configurations for BM-Case 1;

FIG. 5 shows a method of measurement control during handovers for some embodiments with respect to the user equipment;

FIG. 6 shows a method of measurement control during handovers for some embodiments with respect to the node(s);

FIGS. 7a and 7b show an example implementation of some embodiments with respect to conditional handovers operations; and

FIGS. 8a, 8b and 8c show an example implementation of some embodiments with respect to LTM (Lower layer Triggered Mobility) operations.

### DETAILED DESCRIPTION OF EMBODIMENTS

The concept as discussed in further detail with respect to the following embodiments is the implementation of control of training data collection functionality or procedure for machine learning models employed to assist network operations within cellular or mobile communication networks, and specifically the control of training data collection functionality or procedure during user equipment (UE) hand-over (HO) procedures. For example, the UE can be configured to implement data collection wherein the collected data can be used for either training a one-sided (UE or network) or two-sided model (model at both the UE and the network). The UE can be configured to collect data based on data collection configuration information received from the network, that guides the UE to perform data collection (resource to use, periodicity, etc).

The following abbreviations that may be found in the specification and/or the drawing figures are defined as follows:
3GPP third generation partnership project
5G fifth generation
5GC 5G core network
5GS 5G system
6G sixth generation
AF application function
AI artificial intelligence
AMF access and mobility management function
BM beam management
CHO conditional handover
CSI channel state information
CSI-RS channel state information reference signal
CU centralized unit
DCI downlink control information
DN data network
DU distributed unit
gNB (or gNodeB) base station for 5G/NR, i.e., a node providing NR user plane and control plane protocol terminations towards the UE, and connected via the NG interface to the 5GC
HO handover
ID identity
KPI key performance indicator
L1 layer
LCM Life cycle management
LTE long term evolution
LSTM long short term memory
LTM Lower layer Triggered Mobility
MAC medium access control
MAC-CE medium access control-control element
ML machine learning
MME mobility management entity
MSE mean square error
ng or NG new generation
NN neural network
NR new radio
N/W or NW network
PLMN public land mobile network
PHY physical layer
PRACH physical random access channel
RA Random access
RACH random access channel
RAN radio access network
RRC radio resource control
RSRP reference signal received power
RX receiver
SGW or S-GW serving gateway
SMF session management function
SN sequence number
SSB synchronization signal block
TX transmitter
UE user equipment (e.g., a wireless, typically mobile device)
UPF user plane function

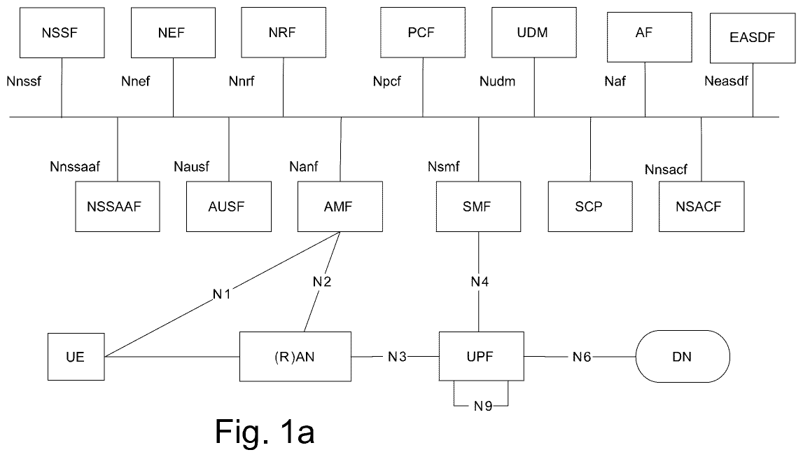

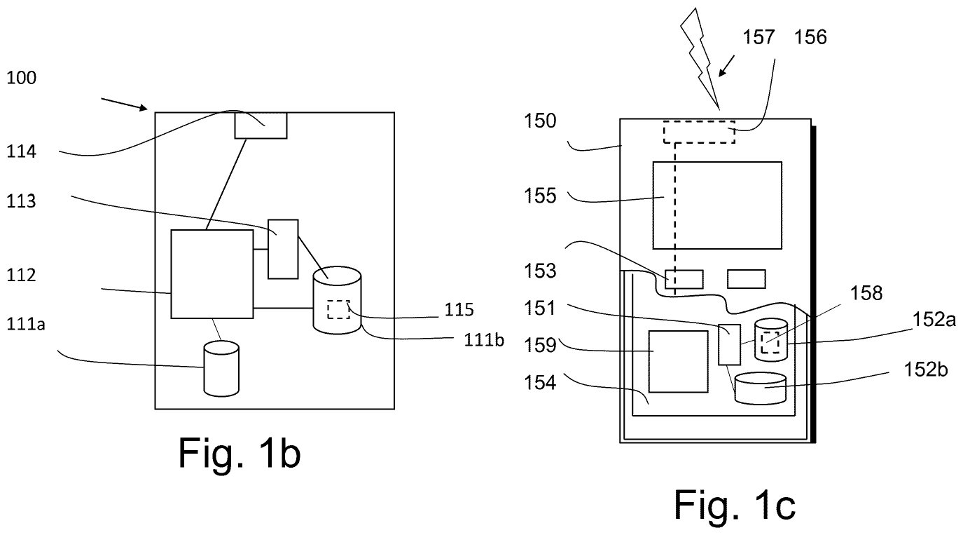

In the following certain embodiments are explained with reference to communication devices capable of communication via a wireless cellular system and mobile communication systems serving such communication devices. Before explaining in detail, the exemplifying embodiments, certain general principles of a wireless communication system, access systems thereof, and communication devices are briefly explained with reference to FIGS. 1a, 1b and 1c to assist in understanding the technology underlying the described examples.

FIG. 1a shows a schematic representation of a communication system operating based on a 5th generation radio access technology (generally referred to as a 5G system (5GS)). The 5GS may comprise a (radio) access network ((R)AN), a 5G core network (5GC), one or more application functions (AF) and one or more data networks (DN). A user equipment may access or connect to the one or more DNs via the 5GS.

The 5G (R)AN may comprise one or more base stations or radio access network (RAN) nodes, such as a gNodeB (gNB). A base station or RAN node may comprise one or more distributed units connected to a central unit.

The 5GC may comprise various network functions, such as an access and mobility management function (AMF), a session management function (SMF), an authentication server function (AUSF), a user data management (UDM), a user plane function (UPF), a network data repository, a network exposure function (NEF), a service communication proxy (SCP), edge application server discovery function (EASDF), policy control function (PCF), network slice access control function (NSACF), network slice specific authentication and authorization function (NSSAAF), and/or network slicing selection function (NSSF).

FIG. 1b illustrates an example of an apparatus 100. The apparatus 100 may be provided in a communications device and/or in a network entity. The apparatus 100 may have at least one processor and at least one memory storing instructions that, when executed by the at least one processor cause one or more functions to be performed. In this example, the apparatus may comprise at least one random access memory (RAM) 111a, and/or at least one read only memory (ROM) 111b. The apparatus may comprise at least one processor 112, 113 and/or an input/output interface 114. The at least one processor 112, 113 may be coupled to the at least one memory which in this example is the RAM 111a and the ROM 111b. The at least one processor 112, 113 may be configured to execute an appropriate software code 115. The software code 115 may, for example, allow the apparatus to perform one or more steps of one or more of the present aspects.

FIG. 1c illustrates an example of a communication device 150. The communication device 150 may be any device capable of sending and receiving radio signals. Other non-limiting examples of a communication device 150 comprise a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like.

The communication device 150 may send or receive, for example, radio signals carrying communications. The communications may be one or more of voice, electronic mail (email), text message, multimedia, data, machine data and so on.

The communication device 150 may receive radio signals over an air or radio interface 157 via a transceiver apparatus 156. The transceiver apparatus 156 may be provided for example by means of a radio part and associated antenna arrangement. The antenna arrangement may be arranged internally or externally to the mobile device and may include a single antenna or multiple antennas. The antenna arrangement may be an antenna array comprising a plurality of antenna elements.

The communication device 150 may be provided with at least one processor 151, and/or at least one memory. The at least one memory may be at least one ROM 152a, and/or at least one RAM 152b. Other possible components 153 may be provided for use in software and hardware aided execution of tasks it is designed to perform, including control of access to and communications with access systems, such as the 5G RAN and other communication devices. The at least one processor 151 is coupled to the RAM 152b and the ROM 152a. The at least one processor 151 may be configured to execute instructions of software code 158. Execution of the instructions of the software code 158 may for example allow the communication device 150 to perform one or more operations. The software code 158 may be stored in the ROM 152a. It should be appreciated that in other embodiments, any other suitable memory may be alternatively or additionally used.

The at least one processor 151, the at least one ROM 152a, and/or the at least one RAM 152b can be provided on an appropriate circuit board, in an integrated circuit, and/or in chipsets. This feature is denoted by reference 154.

A machine learning module may be provided which provides circuitry to support one or more machine learning models. The circuitry may comprise neural network circuitry or any other suitable circuitry for supporting a machine learning model.

The communication device 150 may optionally have a user interface such as keypad 155, touch sensitive screen or pad, combinations thereof or the like. Optionally, the communication device may have one or more of a display, a speaker and a microphone.

In the following examples, the term UE or user equipment is used. This term encompasses any of the example of communication device 150 previously discussed and/or any other communication device.

An example of wireless communication systems are architectures standardized by the 3rd Generation Partnership Project (3GPP). The current radio access technology being standardized by 3GPP is often referred to as 5G or NR. Other radio access technologies standardized by 3GPP include long term evolution (LTE) or LTE Advanced Pro of the Universal Mobile Telecommunications System (UMTS). Wireless communication systems generally include access networks, such as radio access networks operating based on a radio access technology that include base stations or a radio access network nodes. Wireless communication systems may also include other types of access networks, such as a wireless local area network (WLAN) and/or a WiMAX (Worldwide Interoperability for Microwave Access) network.

It should be understood that example embodiments may also be used with standards for future radio access technologies such as 6G and beyond.

Some embodiments may generally relate to Artificial Intelligence (AI)/Machine Learning (ML). Some embodiments may relate to AI/ML for the air interface. This may be for NR, 5G or any other suitable standard.

There is a REL-18 Study Item (see, e.g., Artificial Intelligence (AI)/Machine Learning (ML) for NR Air Interface described in RP-213599 (https://www.3gpp.org/ftp/TSG_RAN/TSG_RAN/TSGR_94e/Docs/RP-213599.zip)).

The study item aims at exploring the benefits of augmenting the air interface with features enabling support of AI/ML-based algorithms for enhanced performance and/or reduced complexity and/or reduced overhead. The target of the study item is to lay the foundation for future air-interface use cases leveraging AI/ML techniques. The initial set of use cases to be covered include channel state information (CSI) feedback enhancement (e.g., compression of CSI reports, overhead reduction, improved accuracy, prediction), beam management (e.g., beam prediction in time, and/or spatial domain for overhead and/or latency reduction, beam selection accuracy improvement), and positioning accuracy enhancements. For those use cases, the benefits may be evaluated (e.g. utilizing developed methodology and defined key performance indicators (KPI)) and potential impacts on the specification(s) may be assessed, including PHY layer aspects and protocol aspects. Furthermore TR 38.843 explores the benefits of augmenting the air-interface with features enabling improved support of AI/ML. The 3GPP framework for AI/ML is studied for air-interface corresponding to each target use case regarding aspects such as performance, complexity, and potential specification impact.

Some embodiments may be used with any of these use cases or any other suitable use case.

Some embodiments may relate to the following study item: “The AI/ML approaches for the selected sub use cases need to be diverse enough to support various requirements on the gNB-UE collaboration levels.”

A collaboration level may indicate whether either the gNB or the UE or both are “running” ML enabled functionality, and how and what information flows are provided between the gNB and UE to allow “running” of such ML enabled functionality. This may include life cycle management aspects such as data collection, model training, model inference, model monitoring functions, and/or the like.

It may be noted that other embodiments may relate to the work item phase of “AI/ML for air interface”. This work item looks to explore the benefits of augmenting the air-interface with features enabling improved support of AI/ML-based algorithms for enhanced performance and/or reduced complexity and/or reduced overhead. The enhanced performance may depend on the considered use cases and may be, for example, improved throughput, robustness, accuracy, and/or reliability, etc. One outcome of the work item may be that sufficient use cases will be considered to enable the identification of a common AI/ML framework, including functional requirements of AI/ML architecture, which may be used in subsequent projects. The study may also identify areas where AI/ML may improve the performance of air-interface functions. Specification impact may be assessed in order to improve the overall understanding of what would be required to enable AI/ML techniques for the air interface.

Some embodiments as described herein may generally relate to one or more AI/ML models. For example, an AI/ML model(s) may be located with each of a UE and a base station (e.g. split between multiple nodes, or a separate model at each node). Alternatively, an AI/ML model may be located with one of a UE or a base station.

An AI/ML model may be implemented by a neural network. A neural network (NN) is a computation graph consisting of two or more layers of computation. Each layer may consist of one or more units, where each unit may perform an elementary computation. A unit may be connected to one or more other units, and the connection may have a weight associated with it. The weight may be used for scaling the signal passing through the associated connection. Weights may be learnable parameters, i.e., values which can be learned from training data. There may be other learnable parameters, such as those of batch-normalization layers.

Machine learning models may be utilized in an ever increasing number of applications for many different types of device, such as mobile phones, as described above. Examples of applications may include image and video analysis and processing, social media data analysis, device usage data analysis, as well as the examples previously discussed.

Neural networks, and other machine learning tools, may be able to learn properties from input data, either in a supervised way or in an unsupervised way. Such learning may be the result of a training algorithm, or of a meta-level neural network providing a training signal.

A training algorithm may consist of changing some properties of the neural network so that the output of the neural network is as close as possible to a desired output. Training may comprise changing properties of the neural network so as to minimize or decrease the error in the output, also referred to as the loss. Examples of losses include mean squared error (MSE), cross-entropy, etc. In recent deep learning techniques, training is an iterative process, where, at each iteration, the algorithm modifies the weights of the neural network to make a gradual improvement of the network's output, i.e., to gradually decrease the loss.

Training a neural network comprises an optimization process from a limited training dataset. In other words, the neural network learns from a limited training dataset and then can be applied to further data, i.e., data which was not used for training the model. In practice, data may be split into at least two sets, a training set and a validation set. The training set may be used for training the network, i.e., for modification of its learnable parameters in order to minimize the loss. The validation set may be used for checking the performance of the neural network with data which was not used to minimize the loss (i.e. which was not part of the training set), where the performance of the neural network with the validation set may be an indication of the final performance of the model. The errors on the training set and on the validation set may be monitored during the training process to understand if the neural network is learning at all and if the neural network is learning to generalize.

In the present description, the terms “model”, “AI model”, and “ML model” may be interchanged with each other. Where an example embodiment is described with reference to one type of model, another type of model may be substituted.

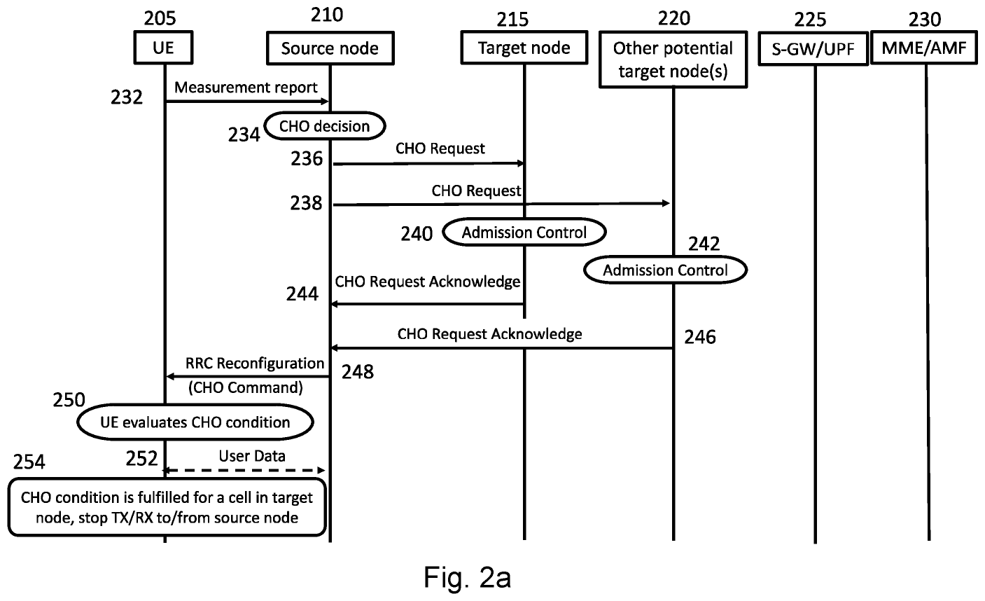

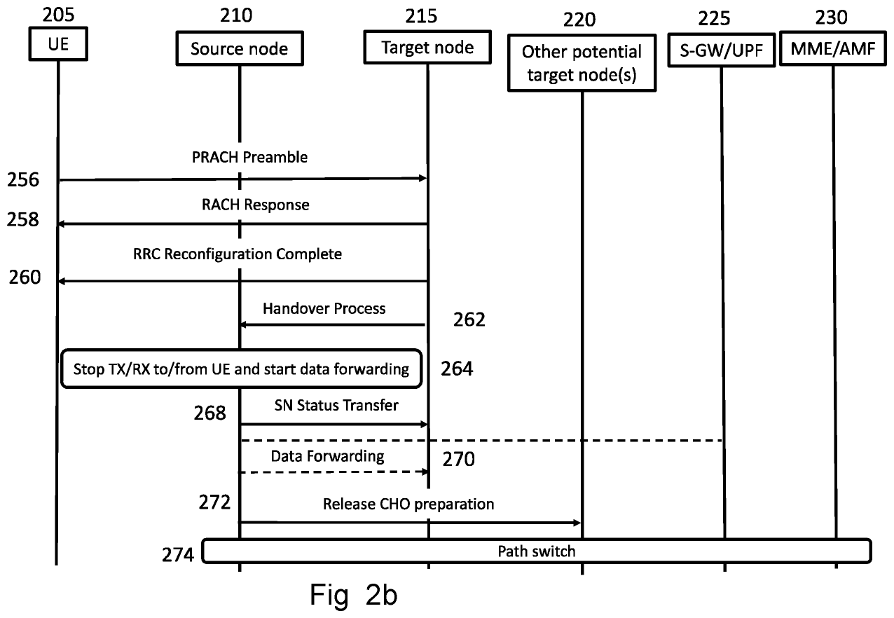

Conditional handover (CHO) aims to improve mobility performance of the UE by aiming to reduce the number of mobility failures. Referring now to FIGS. 2a and 2b, illustrated is an example message sequence chart for conditional handover. Portions of FIGS. 2a and 2b may be similar to handover as described in NR Rel. 15 [TS 38.300].

A configured event may trigger the UE 205 to send a measurement report 232 to a source node 210. Based on this report, the source node 210 may make a CHO decision 234 to prepare one or more target cells for the handover. The source node 210 may transmit a CHO request 236 to a target node 215, and, optionally, a CHO request 238 to one or more other potential target nodes 220. The target node 215 may perform admission control 240. Optionally, one or more of the other potential target nodes 220 may perform admission control 242. The target node 215 may transmit, to the source node 210, a CHO request acknowledge message 244. Optionally, one or more of the other potential target nodes 220 may transmit to the source node 210 a CHO request acknowledge message 246. The source node 210 may then send an RRC Reconfiguration CHO command 248 to the UE 205.

For baseline handover, the UE may immediately access the target cell to complete the handover. Instead, for CHO, the UE 205 may only access the target cell 215 once an additional CHO execution condition expires i.e. the HO preparation and execution phases are decoupled. The condition may be configured by the source node in HO Command. Accordingly, the UE 205 may evaluate one or more CHO conditions 250. Optionally, the UE 205 and the source node 210 may exchange user data 252. At 254, once the CHO condition is fulfilled for a cell in the target node 215, the UE 205 may stop TX/RX to/from the source node 210, and begin handover HO. At 256, the UE 205 may transmit, to the target node 215, a PRACH preamble. At 258, the target node 215 may transmit, to the UE 205, a RACH response. At 260, the UE 205 may transmit, to the target node 215, an RRC Reconfiguration Complete message.

Once the UE 205 completes the handover to the target cell 215 e.g. UE has sent RRC Reconfiguration Complete 260, the target cell 215 may send to the source cell 210, a “Handover Success” indication 262. When receiving this indication from target cell, at 264 the source cell 210 may stop its TX/RX to/from UE and starts data forwarding to the target cell 215 e.g. SN status transfer 268 to target node 215, data forwarding 270 to target node 215 and S-GW/UPF 225. Moreover, at 272 the source node 210 may release the CHO preparations in the one or more other target nodes/cells e.g. 220 which are no longer needed when it receives “HO Success” indication. At 274, path switch may be performed between the source node 210, target node 215, S-GW/UPF 225, and MME/AMF 230.

An advantage of the CHO is that the HO command may be sent very early, when the UE is still safe in the source cell, without risking the access in the target cell and the stability of its radio link. That is, conditional handover may provide mobility robustness and protection against mobility failure.

Although the above and following handover examples show example CHO examples, it would be appreciated that the examples and embodiments can be applied without significant inventive effort to HO use cases.

Furthermore some embodiments can be applied to other example mobility scenarios such as Lower layer Triggered Mobility—LTM (NW-triggered)

The procedure for LTM can be summarized under three main steps. The Network comprises Centralized Unit (CU) and Decentralized Units (DU). The CU provides support for the higher layers of the protocol stack such as SDAP, PDCP and RRC while DU provides support for the lower layers of the protocol stack such as RLC, MAC and Physical layer. During the preparation phase, the UE sends measurement reports containing the measurements of the serving and target cells. Based on the received measurement reports, the Centralized Unit (CU) configures the LTM candidate cells, which are then forwarded to the UE by using an RRC Reconfiguration message. During the execution phase, the UE reports measurements to the serving Decentralized Unit (DU), which makes a decision on whether to trigger the cell switch (e.g, by checking that L1-RSRP of target beam measurement>L1-RSRP of serving beam measurement+Offset for a time period (i.e. Time-to-Trigger (TTT) period). In this case, the DU triggers the HO by sending a MAC CE command to the UE, which can then try to connect to the target DU. During the completion phase, the UE context is released from the source DU and the path switch is performed to the new serving DU.

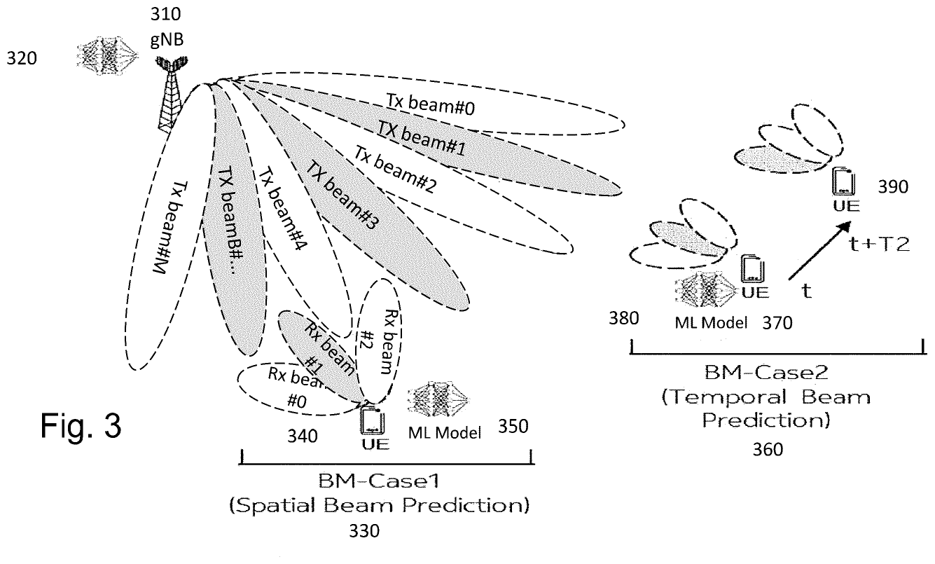

Reference is furthermore made to FIG. 3 which shows some non-limiting example beam management (BM) use cases for AI/ML. In the example, a gNB 310 may be configured with an ML model 320. The gNB 310 may transmit multiple different TX beams. In a first BM use case 330, spatial beam prediction may be performed by a UE 340 configured with a ML model 350 by predicting Tx beam #1 or Tx beam #3 given Tx beam #0, Tx beam #2 and Tx beam #4 for example. The spatial beam prediction provides, as an outcome of an ML model inference, at least a prediction of the “best beam” ID (s) (e.g., best in terms of a link quality metric DL signal strength—i.e., RSRP) in a larger set of beams (Set A) predicted from a smaller set of beams (Set B) thus utilizing fewer DL reference signal resources and optionally a confidence interval of the prediction (e.g., 95%) and RSRP for the beam ID (s) may also be reported. Current discussions in 3GPP indicate a maximum of 8 beam ID(s) to be predicted in the list of Top K predicted beams. However, other scenarios may use more or less than a maximum of 8 beam IDs to be protected.

In a second BM use case 360, temporal beam prediction may be performed with a UE 370 configured with a ML model 380, which may be at a first location 370 at time t and at a second location 390 at time t+T2, by predicting a best beam which may serve the UE at further instants of time or further instants of time in a future time window. This allows preparation of resources well in advance for those beams that have been predicted. This may provide a lower interruption time during beam switching procedures. This may, for example, improve user throughput and experience.

Legacy beam management procedures P1, P2, P3 require the time-consuming operation of sweeping all the Tx and Rx beams by configuring the UE with a large number of SSB/CSI-RSs measurements.

The Rel-18 study item discussed earlier relates to AI/ML-assisted beam management for overhead savings and latency reduction. Sub-use cases for further study include BM-Case 1 spatial beam prediction 330 and BM-Case2 time beam prediction 360. For each sub-use case, the optimization targets may comprise: DL TX beam prediction (P1/P2 joint optimization); and DL TX-RX beam pair prediction (P1/P2/P3 joint optimization). Performance targets and/or KPIs may comprise one or more of: one or more beam prediction accuracy related KPIs (e.g. prediction accuracy, and/or RSRP difference); and/or one or more system performance related KPIs (e.g. UE throughput, control signal overhead, and/or power consumption).

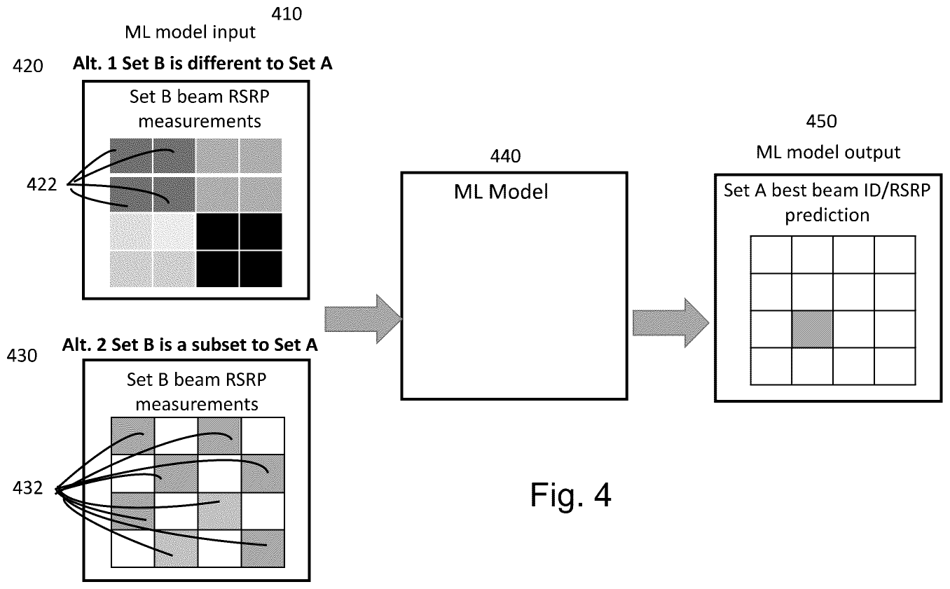

Referring now to FIG. 4 which shows configurations for BM-Case 1 (i.e. spatial beam prediction). Different ML model input 410 is possible for an ML model 440. In a first alternative 420 (Alt-1), set B may be different from set A. In other words, various different beam RSRP measurements may be input. Illustrated are bitmap positions on a grid for corresponding reference signals e.g. 422.

In a second alternative 430 (Alt-2), set B may be a subset of set A. The output 450 of the ML model 440 may be that set A is the best beam ID/RSRP prediction. Illustrated are bitmap positions on a grid for corresponding reference signals e.g. 432.

One non-limiting example of Alt-1 may allow the UE to perform a prediction of a narrow beam in Set A based on a wide beam in Set B. The same example may allow an extension with even different reference signals used, for example Set B may use SSB based beams, whereas Set A may predict CSI-RS based beams.

Another non-limiting example of Alt-2 may allow predicting the Set A from Set B based on same type of reference signal (i.e., wide beam to wide beam or narrow to narrow, hence the term subset).

3GPP has discussed the following configurations for BM-Case 1 (i.e., spatial beam prediction). For the AI/ML input 410, L1-RSRP measurements may be of a subset of narrow beams, and/or of wide beams. For the AI/ML input 410, assistance information (i.e. beam shape information, beam ID) may be input. For the AI/ML output 450, the best narrow beam ID or best narrow beam RSRP, or (internal) QoS value for beam selection may be output. An (offline) 5G system level simulator may provide model training data to the ML model 440.

It may be noted that the ML model 440 may be a UE-side ML model, a network-side ML model, a one-sided ML model, or a two-sided ML model. In other words, the inference of the ML model may be performed entirely at the UE side, entirely at the network side, or partially at the UE side and partially at the network side, where ML models at each side are paired together to produce a joint inference.

While FIGS. 3 and 4 relate to use of AI/ML models for beam management, these examples are not limiting; AI/ML models may be used for other purposes, including but not limited to CSI feedback enhancement and positioning accuracy. Other uses of AI/ML models may be substituted where appropriate with regard to example embodiments of the present disclosure.

As discussed above the embodiments discussed herein aim to enable control of the data collection during UE hand-over procedures. For example, the UE can be configured to implement data collection wherein the collected data can be used for either training a one-sided (UE or network) or two-sided model (model at both the UE and the network). The UE can be configured to collect data based on data collection configuration information received from the network, that guides the UE to perform data collection (resource to use, periodicity, etc).

For example, a specific use case can be beam prediction in time and spatial domain, wherein the UE ML model is capable of predicting the top K beams for a prediction window Twin when the UE is being served for a given Cell such as described above.

In this scenario, during the HO procedure, the UE is configured to (required to) perform target cell (and beam) measurements.

Furthermore, during the HO procedure, the UE moves from source cell X to target cell Y and during this move there could be a potential situation where the data collection process may not be able to operate correctly.

This failure to obtain accurate or effective data collection can be for reasons such as:
Data may change its distribution ‘abruptly’ at a certain point during handover and may corrupt training data (and the ML training accuracy) if no action is taken;
Certain events in the UE which may influence data collection can be, for example:
   source radio link quality can be non-optimal (with a chance of Radio link failure—RLF),
   sample quality can be impacted by the UE attempting to optimize some measurements due to power saving,
   UE is forced to fallback to other modes—for example a CHO fallback to source cell as no target cell has satisfied the execution condition yet,
Data collection samples may not have a sufficiently good radio quality due to neighbouring cell interference (this can occur in the case of intra-frequency HO which is the dominant type of HO in NR networks).

Instead of using the potentially “corrupted” training data, the examples can, as discussed in further detail herein, suspend training data collection during HO and/or switch to a separate ‘quarantine’ training data collection buffer—for example a handover data collection rather than a ‘normal’ training data collection buffer.

Where the training is offline (if no reinforcement or continual learning is used) then the training data collection can be delayed without significantly affecting network functionality.

In the following examples there is shown apparatus configured to suspend training data collection during HO (or handover event) in a manner that is consistent with network expectations (e.g., data that is being collected conforms to a distribution with given parameters. In other words the apparatus configured to implement some embodiments can be configured to ignore or suspend the determination of mean and variance for training data sample values under radio link failure conditions should be ignored, or ignore or suspend obtaining training data sample values for beam prediction when beam failure recovery is ongoing.

The concept as discussed in the following embodiments in further detail is one wherein a UE which is configured for training data collection can be configured to proactively inform the network about a possible impact on training data collection in anticipation of a possible HO event and reports this information during the measurement reporting procedure.

Furthermore in some embodiments the source and target nodes (gNB(s) or DU(s) with CU) can be configured to coordinate training data collection configuration that is used by the UE to evaluate the conditions for suspension of a data collection session during HO. The UE training data collection suspension/resumption can in such examples be fully under network control.

In some embodiments the training data collection configuration can be linked by the source cell to a set of handover measurement conditions (e.g., HO execution conditions). Thus these conditions cause a decision to be made which allows a determination of whether training data collection is suspended or not.

Furthermore in some embodiments where training data collection is suspended for HO, a UE may be configured to implement training data collection for a HO-specific ML model. This can be implemented in some embodiments where the network has configured the UE with information identifying the conditions to collect training data during a HO procedure/time period. The HO procedure/time-period in some embodiments can refer to the operations and/or time-period the HO but could also refer also to operations and/or time-period of the HO procedure and include an extended period shortly-before and shortly-after the HO operations and/or time period.

In some embodiments the UE can be configured to maintain more than one (separate) training data collection buffers in order to isolate any collected training data during the handover procedure to allow subsequent processing and routing between source and target cells/beams of the collected training data after the completion of the handover procedure.

Thus, in some embodiments, the UE can be configured to inform the state of the training data collection to the target node, after completion of the handover. A state of the training data collection can be, for example, whether the training data was suspended, or whether the training data was collected but collected in a hand-over model training data buffer rather than a ‘normal’ model training data buffer.

The target node can then be configured in some embodiments to retrieve the available training data buffers from the UE and coordinates the processing of these data buffers with the source node.

For example, if two data distributions are fully uncorrelated or are not similar (or have a correlation coefficient below a threshold value), the previous collected training data information can be discarded to prevent contamination of the later collected data and thus prevent contamination of the machine learning model.

In some embodiments the network can be configured to employ a guard timer to ensure that the data collection resumption is delayed in case there is a possible mobility ping-pong between target and source nodes.

As detailed in the examples herein these embodiments are applicable to L3 HO procedures (both baseline and conditional HO) as well as to LTM (Lower Layer Triggered Mobility) which is a L1/L2 triggered mobility.

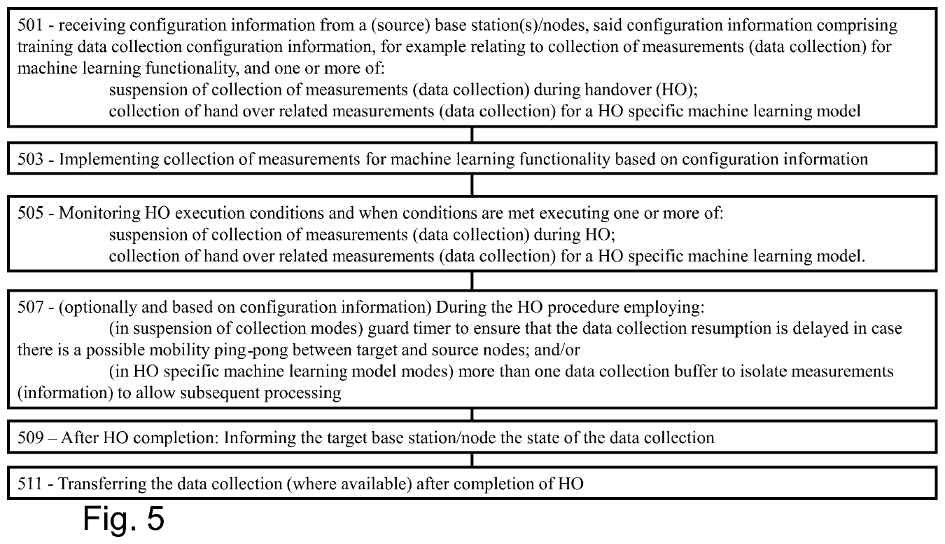

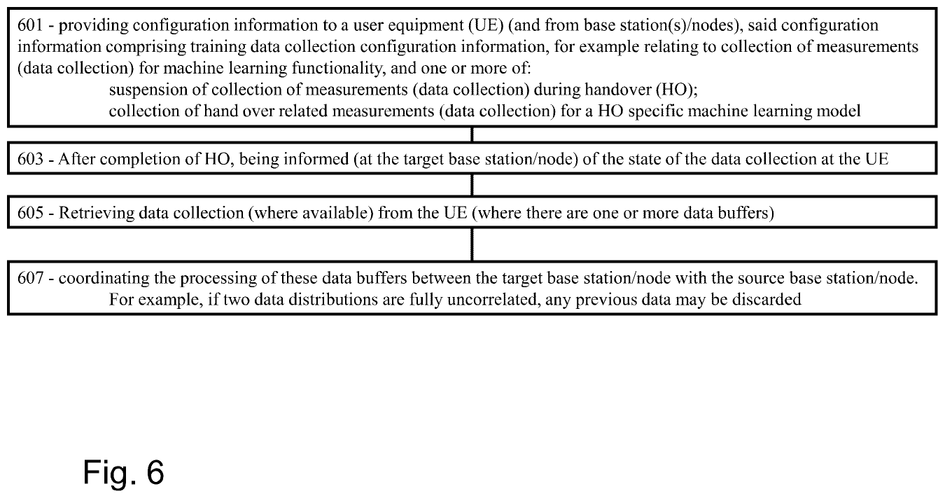

With respect to FIGS. 5 and 6 there are shown flow diagrams describing operations performed by the UE (FIG. 5) and the network (FIG. 6), such as the source and/or target node, in implementing some embodiments of handover based control of training data collection for machine learning functionality, for example suspension of data collection or data quarantining or model buffer separation during handover.

Thus, with respect to the UE FIG. 5 shows an initial operation of receiving configuration information from a (source) base station(s)/nodes. In some embodiments the configuration information comprises training data collection configuration information, for example relating to collection of measurements (training data collection) for machine learning functionality. Furthermore in some embodiments the training data collection configuration information comprises information for controlling suspension of collection of measurements or training data collection during handover (HO) and/or controlling a collection of training data collection during HO for a HO specific machine learning model. This receiving operation is shown in FIG. 5 by 501.

The UE can then be configured to implement collection of measurements for machine learning functionality based on the received configuration information as shown in FIG. 5 by 503. This is the ‘normal’ data collection mode where, based on the configuration information, the UE collects measurements for a machine learning model.

The UE furthermore is configured to, as shown by FIG. 5 step 505, monitor HO execution conditions and when the HO execution conditions are met then executes a suitable measurement collection control based on the configuration information. The measurement collection controls can, for example, be implementing one or more of:

Suspending collection of measurements (training data collection) with respect to the machine learning model during HO;

Implementing a collection of measurements (training data collection) with respect to a hand over related machine learning model during HO.

Optionally and based on configuration information as shown in FIG. 5 step 507, during the HO procedure there can be employed a guard timer in order to ensure that any data collection resumption for the machine learning model is delayed in case there is a possible mobility ping-pong between target and source nodes. Furthermore optionally the UE can be configured to employ more than one data collection buffer to isolate measurements (information) to allow subsequent processing.

Following the completion of the HO, as shown in FIG. 5 by step 509, there is the operation of informing the target base station or node the state of the data collection (for example that there has been a suspension of data collection and/or there was a handover specific or separate data collection during HO.

The UE can then be configured, such as shown in FIG. 5 by step 511, to transfer any collected training data (where available) after completion of the HO.

Furthermore, with respect to the base station or nodes, FIG. 6 shows an initial operation of providing configuration information from a (source) base station(s)/nodes to a UE. In some embodiments the configuration information comprises training data collection configuration information, for example relating to collection of measurements (data collection) for machine learning functionality.

The UE, as discussed above, is configured to monitor and initiate the HO procedure when suitable.

Following the completion of the HO, as shown in FIG. 6 by step 603, there is the operation of being informed at the (target) base station or node of the state of the data collection at the UE. For example the UE can be configured to indicate that there had been a suspension of training data collection and/or there had been a handover specific or separate training data collection performed during HO. Furthermore in some embodiments the base station or node can be informed that following the completion of the HO procedure that the training data collection has been resumed.

The (target) base station or node can then be configured (following the completion of the HO), to receive any collected data (where available) from the UE such as shown in FIG. 6 by step 605.

Then, as shown in FIG. 6 by step 607, the (target) base station or node is configured to coordinate the processing of the received collected data, for example from the data buffers between the target base station/node with the source base station/node. For example, in situations where there are data distributions for collected data before and after the HO which are fully uncorrelated, then any previous data may be discarded.

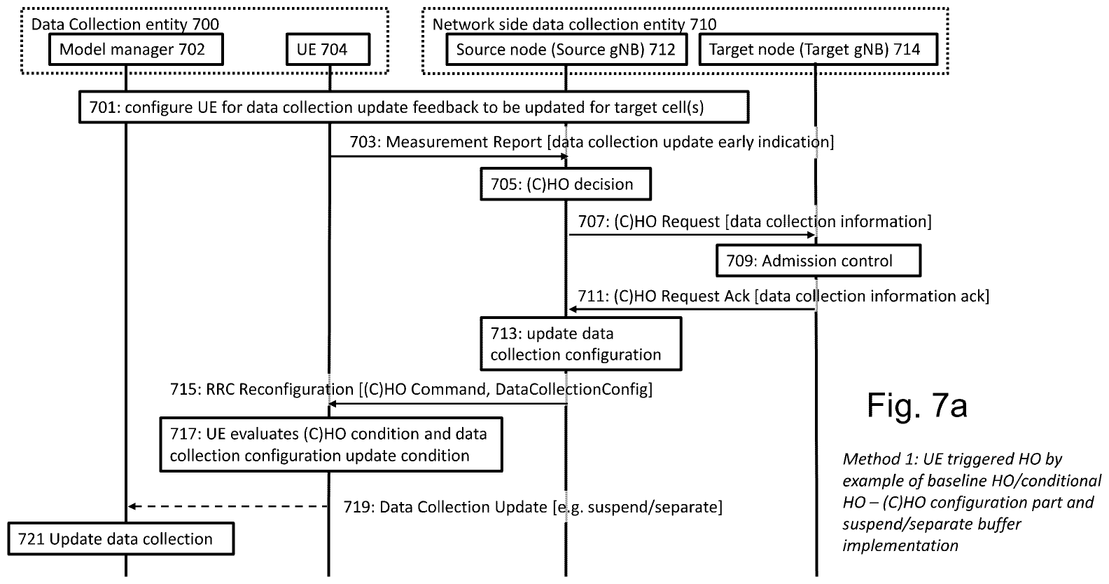

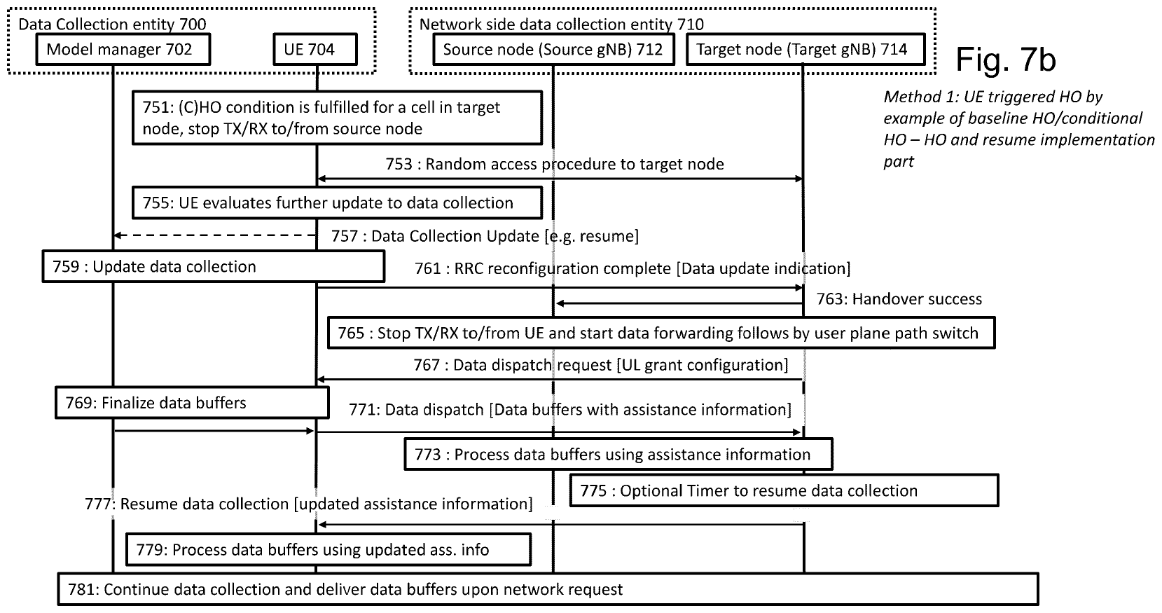

With respect to FIGS. 7a and 7b is shown a specific implementation of the operations as described above within a UE triggered HO by example of baseline HO/conditional HO.

In this example a data collection entity 700 comprises a model manager 702 and a UE 704. In this example it is assumed that the UE model manager 702 functionality (implementation specific) is responsible for the training data collection in the UE 704. It may be collocated with the UE 704 or is an external entity (e.g., an external UE-vendor server) having a connection with the UE 704. As a pre-requisite the UE 704 is configured to collect data at the UE side that will be eventually used for offline training of an ML-enabled functionality/feature (e.g., beam prediction, CSI compression, etc.).

In some embodiments the UE model manager does not comprise an interface to the network, but may comprise the following functions:
1. Training data sample collection for the given use case using the resources in the UE based on the configuration provided by the network (e.g., reference signal configuration)
2. Buffering of training data samples
3. Buffering of multiple training data buffers
4. Interfacing with an external server with a PDU session to store/retrieve training data samples/buffers
5. Ability to organize or associate the training data with a Model/Functionality using an ID that has been discussed earlier.

Additionally in this example are shown the network side data collection entity 710 which comprises a source node (source gNB) 712 or source base station and a target node (target gNB) 714 or target base station.

The first step as shown by 701 is configuring the UE for data collection update feedback to be updated for target cell(s). As discussed this data collection information is configured to define the collection of the data at the UE.

The UE 704 is sensitive to changes in the conditions of the cells that influence ongoing data collection based on an earlier configuration from the network asking the UE to report any conditions (or context information) that impact the ongoing data collection. For example these conditions can be when source radio link quality is not optimal (and therefore there is a chance of RLF), when the UE is optimizing some measurements due to power saving reasons and sample quality is impacted.

As part of the measurement report the UE 704 can be configured to indicate, such as shown by 703, data collection update early indication information to a source node 712. This data collection update early indication information indicates that the upcoming or potential HO will cause a possible impact to data collection (as an early indication). In other words the information implies the UE might have to restrict the collection of data with respect to a set of target cell(s) which may be candidates for CHO.

In case of normal HO the UE can be configured to trigger this data collection suspension when HO is highly likely (based on an evaluation of current HO conditions). For example, a possible reason could be that a target cell does not transmit the necessary reference signals to allow the data collection to happen, the quality of the radio signal is below a threshold (X=−95 dBm) that might impact ongoing data collection, etc.

When the source node 712 is configured to make the (C)HO decision, for example as shown by 705 and the source node 712 decides to perform a HO to the target node 714 and uses the data collection update from the UE 704 to at least inform the target node 714 that some additional functions with respect to the collected data at the UE 704 after the completion of the HO will be required. These additional functions can be, for example, retrieval of data buffers, checking data distributions and selectively filtering/discarding data samples in those buffers.

In some embodiments, as shown in by 707, the source node 712 is configured to request the target node 714 to mitigate the conditions that UE 704 reported which impact data collection during HO. For example the target node may allocate additional reference signal resources to the UE to continue data collection. In some further embodiments, the target node 714 may be configured to indicate some additional conditions that further impact data collection with respect to the given target cell. These additional conditions can be, for example, update the reference signal threshold for the UE to (X=−100 dBm) so that the UE can continue data collection.

In some embodiments, such as shown by 709, the target node 714 is configured to update its view to the data collection based on the (C)HO decision (705) and the (C)HO request (707) from the source node. Thus, for example, the target node 714 may update the data collection configuration with a reference signal configuration that is acknowledged based on the source request.

Thus for example the target node 714 implements an admission control 709 based on the received (C)HO request and data collection information. The target node 714 then is configured to generate and transmit back to the source node 712 a (C)HO request acknowledge with a data collection information acknowledgement as shown by 713.

In some embodiments the target node 714 is configured to indicate to the source node 712 which of the data processing capabilities requested by the source node in the (C)HO request are admissible.

The source node 712 can thus update, as shown by 713, the data collection configuration for a set of source/target cell pairs for the UE. This configuration can in some embodiments contain updates for parameters such as: reference signal thresholds; reference signal configurations; and guidance for the UE to collect groups of data during the HO procedure.

In some embodiments the network is configured to guide the UE to suspend the data collection when the reference thresholds are no longer met. This data collection suspension can, for example, be designated the ‘normal’ ML model measurement set.

In some other embodiments the network is configured to control the UE such that the UE continues to collect data when the reference signal thresholds are no longer met but is configured to store this measurement data as a separate data buffer and in some embodiments further marking the conditions and further information to the separate data buffer. The conditions can be for example a time stamp identifying the time when the thresholds are no longer met. In some embodiments the separate data buffer can be designated a HO-specific ML model measurement set.

Furthermore in some other embodiments, the network is configured to guide the UE to perform a data comparison between one or more data sets. The data comparison can be any suitable comparison, for example, using Pearson's coefficient, a correlation test, a hypothesis test on the input distribution through a Kolmogorov-Smirnov test, a Lilliefors test. With respect to this data comparison one data set may comprise the measurement data for the ML model that was suspended (normal ML model) and the other data set may comprise data for HO-specific ML model or a data set can be a merging of the two normal ML model and HO-specific ML model data sets.

In some embodiments, the UE is configured based on the updated data collection configuration to employ implementation specific algorithms for data comparison and report (only) a similarity score/metric. For example a metric of similarity between the normal ML model and HO-specific ML model data sets which ranges between 0 and 100, is reported back to the network.

The source node 712 can then be configured to transmit the (C)HO configuration as well as the data collection configuration to the UE. In some embodiments, as shown by 715 the (C)HO configuration as well as the data collection configuration can be transmitted within a suitable RRC reconfiguration message.

The (C)HO configuration as well as the data collection configuration can then be evaluated by the UE as shown by 717.

The following steps as shown in FIGS. 7a and 7b then relate to the effect of the employed (C)HO configuration conditions being met (and/or the data collection configuration conditions being met) where the (C)HO configuration evaluation indicates that the (C)HO configuration condition has been met (and/or that the data collection configuration conditions are met during the evaluation). This for example can trigger a handover procedure to be implemented (for example the reference signal thresholds are no longer met) and/or that the initiate a change in the data collection.

Thus, for example, the UE is configured to generate a data collection update indicator as shown by 719 based on the data collection configuration condition being met. The data collection update can, for example, be a suspend update or separate indication. In some embodiments the data collection update indication can be generated at intervals (regular or irregular) rather than being triggered by the UE evaluation operation shown by 717.

The model manager 702 can then, on receipt of the data collection update indicator, be configured to update the data collection operation as shown by 721.

Then continued on FIG. 7b is the continuation of HO procedure. Thus as shown by 751 then the (C)HO configuration evaluation which determines a (C)HO configuration condition has been met (for example a suitable target cell reference signal meets the condition).

The UE 704 is configured to perform a random access with the target node 714 as shown by 753.

The UE 704 is furthermore configured to additionally evaluate, as shown by 755, the data collection configuration conditions (with respect to the target node).

When the evaluation determines that these conditions are met then the UE can be configured to determine that the training data collection is to be resumed for the normal ML model, and the UE may collect data normally.

This can cause the UE to generate and transmit a data collection update indicator as shown by 757 (based on the data collection configuration condition being met with respect to the target node). The data collection update can, for example, be a resume update (where the earlier update indicator was a suspend update) or a return update (where the earlier update indicator was a separate update). In a similar manner to before in some embodiments the data collection update indication can be generated at intervals (regular or irregular) rather than being triggered by the UE evaluation operation shown by 755.

The return update can in situations can cause the data collection to return to the earlier data collection set (the normal ML model data set). In some embodiments the data collector is configured to generate more than one data set (e.g., the UE might have 3 data sets, one each for normal ML and HO-specific models and one generated by combining both) with assistance information describing these sets.

The model manager 702 can then, on receipt of the data collection update indicator, be configured to update the data collection operation as shown by 759.

Additionally, the UE, as shown by 761, be configured to indicate to the network (for example the target node 714) that the UE has data collection updated based on the earlier steps. This indication can for example be implemented within the RRC reconfiguration complete message from the UE to the target node. This indication thus allows the target node to prepare for reception of the data sets in the future.

The completion of the HO procedure can be implemented according to a conventional HO process. For example, a handover success message can pass from the target node 714 to the source node 712 as shown by 763.

Additionally there can be a stopping of TX/RX to/from UE and start of data forwarding followed by user plane path switch as shown by 765.

Furthermore in some embodiments the model manager and UE is configured to dispatch the data buffers to the target node using the UL grants indicated by the target node as shown by 767. The data buffers and their associated assistance information can then be received by the target node and the target and source nodes configured to collaborate and process data buffers based on the assistance information in a manner as described above.

In some embodiments an optional timer is implemented, as shown by 775, at the target node before any further data collection information or assistance information is passed back to the UE and before any further data collection is implemented. As discussed above this is to prevent ping-pong operations or multiple switches in data collections from being implemented.

Furthermore in some embodiments the target node 714 may work with the source node 712 to interpret the collected data sets and assistance information and decide to combine (or not combine) the data sets with more advanced processing. For example, the combination of normal ML model data set and HO-specific data set could be improved by selecting a subset of samples from HO specific data set (e.g., from selected timestamps and ignoring others) creating a new processed HO-specific data set by combining with normal ML model data set. In another embodiment data samples may be interpolated for the ignored/missing samples from the HO-specific data set, Once the final data set is prepared it can be consumed for model training within the network (gNB, CU, DU, OAM, LMF, etc.) or forwarded to an external entity (e.g., NWDAF or Application Function outside the 3GPP network).

Thus for example the target node is configured to transmit a resume data collection message to the UE indicating that the target node is able to accept new data as shown by 777. The resume data collection message to the UE can comprise updated assistance information indicating whether to combine data sets (where there are multiple data sets within the data collection and furthermore in some embodiments information for updated data collection configuration to operate in a target cell.

The UE can then be configured to process the data buffers based on the updated assistance information as shown by 779.

The model manager/UE can then continue the data collection and deliver data buffers based on any further network requests as shown by 781.

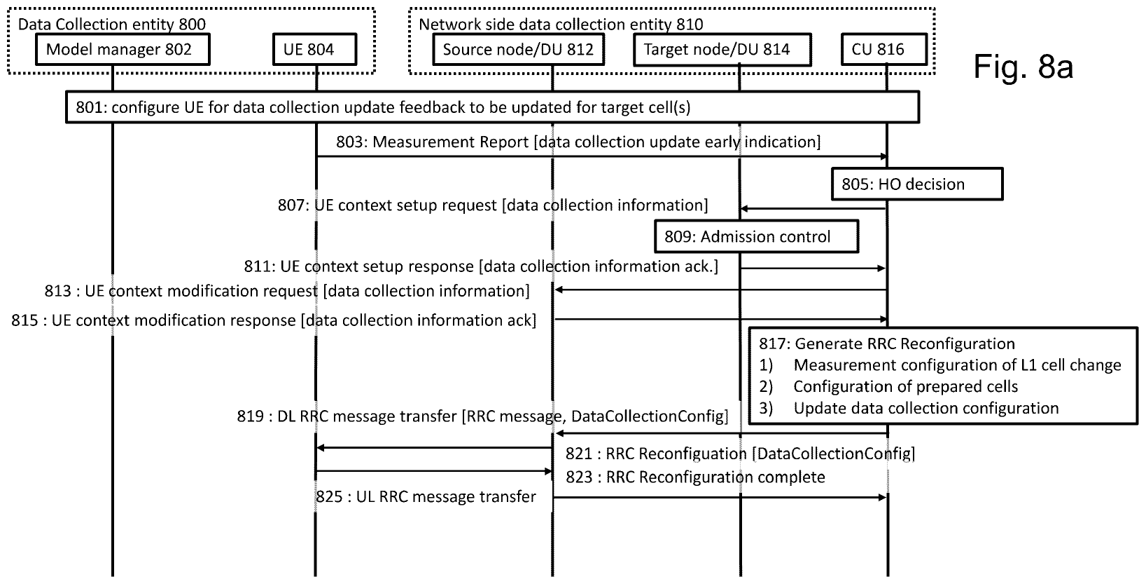

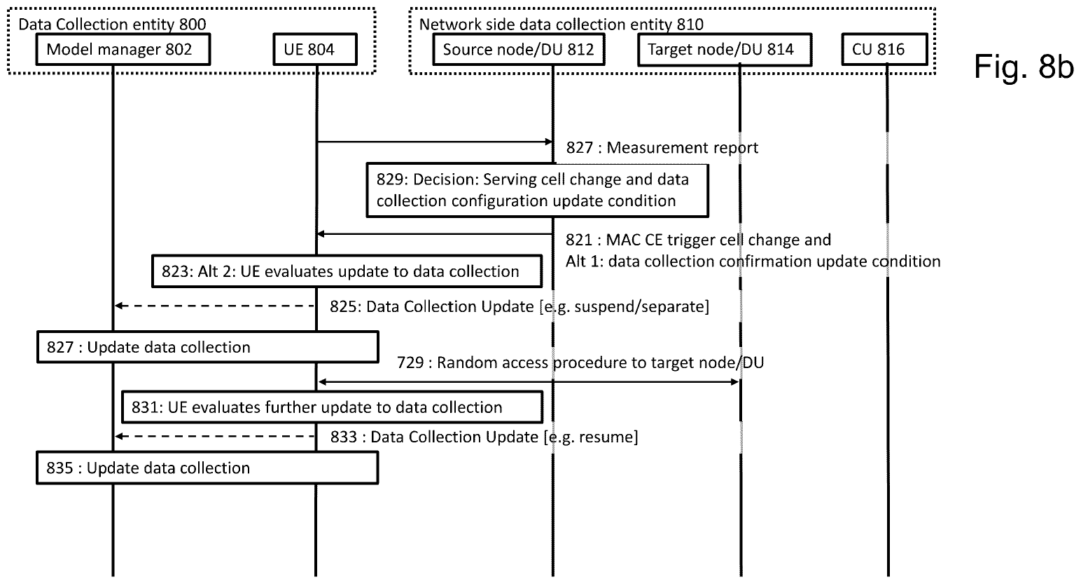

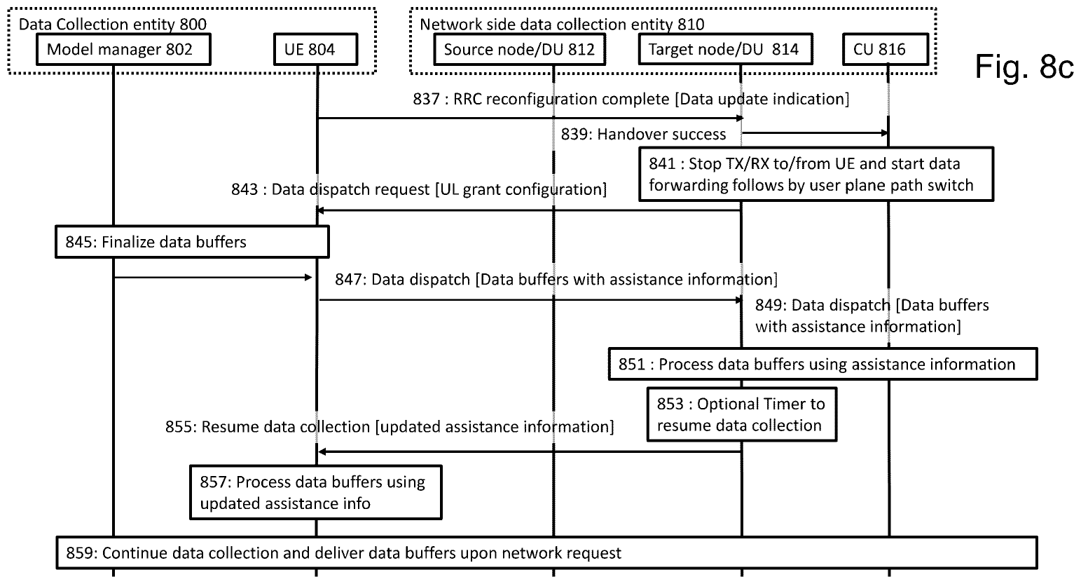

With respect to FIGS. 8a to 8c there is furthermore shown a further implementation of some embodiments when applied to a LTM (Lower layer Triggered Mobility) related HO. These consider the network triggered HO procedures, and present an example of the training data collection suspension (or switching) during the LTM procedure. It should be noted that in LTM, because the network triggers both the cell switch and training suspension, then the network knows exactly when the UE has taken those actions. Thus, in these embodiments no additional assistance information is needed. This is therefore different to the above CHO example where the UE triggers these actions (and therefore in CHO examples without additional signaling/assistance information from the UE, it would be difficult for the network to combine/aggregate the information).

In this example a data collection entity 800 comprises a model manager 802 and a UE 804. In this example it is assumed that the UE model manager 802 functionality (implementation specific) is responsible for the training data collection in the UE 804. It may be collocated with the UE 804 or is an external entity (e.g., an external UE-vendor server) having a connection with the UE 804. As a pre-requisite the UE 804 is configured to collect data at the UE side that will be eventually used for offline training of an ML-enabled functionality/feature (e.g., beam prediction, CSI compression, etc.).

In some embodiments the UE model manager does not comprise an interface to the network, but may comprise the following functions:
1. Training data sample collection for the given use case using the resources in the UE based on the configuration provided by the network (e.g., reference signal configuration)
2. Buffering of training data samples
3. Buffering of multiple training data buffers
4. Interfacing with an external server with a PDU session to store/retrieve training data samples/buffers
5. Ability to organize or associate the training data with a Model/Functionality using an ID that has been discussed earlier.

Additionally in this example are shown the network side training data collection entity 810 which comprises a source distributed unit (DU) 812 or node and a target distributed unit (DU) 814 or target node, and a centralized unit (CU) 816.

The first step as shown by 801 is configuring the UE for data collection update feedback to be updated for target cell(s). As discussed this data collection information is configured to define the collection of the data at the UE.

The UE 704 is sensitive to changes in the conditions of the cells that influence ongoing data collection based on an earlier configuration from the network asking the UE to report any conditions (or context information) that impact the ongoing data collection. For example, these conditions can be when source radio link quality is not optimal (and therefore there is a chance of RLF), when the UE is optimizing some measurements due to power saving reasons and sample quality is impacted.

As part of the measurement report the UE 804 can be configured to indicate, such as shown by 803, data collection update early indication information to a source node 812. This data collection update early indication information indicates that the upcoming or potential HO will cause a possible impact to data collection (as an early indication). In other words, the information implies the UE might have to restrict the collection of data with respect to a set of target cell(s) which may be candidates for LTM. In case of normal HO the UE can instead simply trigger this data collection suspension when HO is highly likely (based on current HO conditions evaluations). One possible reason could be that a target cell does not transmit the necessary reference signals to allow the data collection to happen, the quality of the radio signal is below a threshold (X=−95 dBm) that might impact ongoing data collection.

The source CU 816 in some embodiments, having implemented an HO decision as shown by 805, is configured to configure the LTM for one (or several) target DU(s) 814 and uses the data collection update from the UE 804 to at least inform the target DU(s) 814 that it needs to perform some additional function with respect to the collected data at the UE 804 post the HO (e.g., retrieval of data buffers, checking data distributions and selectively filtering/discarding data samples in those buffers). Thus, for example, the CU 816 transmits to the target DU 814 a UE context setup request which comprises data collection information as shown by 807.

In some further embodiments, the source DU 812 is configured to request the target DU 814 to mitigate the conditions that UE reported which impact data collection during HO. For example, the target node 814 can be configured to allocate additional reference signal resources to the UE to continue data collection. In some further embodiments, the target node 814 can be configured to indicate some additional conditions that further impact data collection with respect to the given target cell for example, update the reference signal threshold for the UE to (X=−100 dBm) so that the UE can continue data collection.

The target DU, furthermore can be configured to, as shown by 809, update its view to data collection and further perform admission control.

Following this, as shown by 811, the target DU 814 is configured to return a context setup response to the CU 816, the context setup response comprising a data collection information acknowledgement.

Furthermore the CU 816 is configured to transmit to the Source DU 812 a UE context modification request, as shown by 813, the context modification request comprising data collection information. The source DU 812 can process the context modification request and respond to the CU 816 with a UE context modification response, as shown by 815, the context modification response comprising data collection information acknowledgement. In such a manner the source DU 812 is configured to also provide the configuration of the UE in the UE Context Modification Response message containing a container from DU to CU. The configuration may contain UE-specific and non-UE-specific parts.

The CU 816 is then configured to update the data collection configuration for a set of source/target cell pairs for the UE. This configuration can in some embodiments comprise updated reference signal thresholds, updated reference signal configurations and guidance for the UE to group the data during the HO procedure.

As described earlier, this can be reflected by the network being configured to guide the UE to suspend the data collection when the reference thresholds are no longer met. This data collection suspension can, for example, be designated the ‘normal’ ML model measurement set.

In some other embodiments the network is configured to control the UE such that the UE continues to collect data when the reference signal thresholds are no longer met but is configured to store this measurement data as a separate data buffer and in some embodiments further marking the conditions and further information to the separate data buffer. The conditions can be for example a time stamp identifying the time when the thresholds are no longer met. In some embodiments the separate data buffer can be designated a HO-specific ML model measurement set.

Furthermore in some other embodiments, the network is configured to guide the UE to perform a data comparison between one or more data sets. The data comparison can be any suitable comparison, for example, using Pearson's coefficient, a correlation test, a hypothesis test on the input distribution through a Kolmogorov-Smirnov test, a Lilliefors test. With respect to this data comparison one data set may comprise the measurement data for the ML model that was suspended (normal ML model) and the other data set may comprise data for HO-specific ML model or a data set can be a merging of the two normal ML model and HO-specific ML model data sets.

In some embodiments, the UE is configured based on the updated data collection configuration to employ implementation specific algorithms for data comparison and report (only) a similarity score/metric. For example a metric of similarity between the normal ML model and HO-specific ML model data sets which ranges between 0 and 100, is reported back to the network.

Thus for example the CU 816 can be configured, as shown by 817, to generate RRC reconfiguration, where the reconfiguration comprises such elements or parameters as Measurement configuration of L1 cell change, Configuration of prepared cells, and Update data collection configuration.

The CU 816 can then, as shown by 819 with respect to a DL RRC message transfer comprising RRC message and DataCollectionConfig elements, be configured to transmit the RRC Reconfiguration message and the data collection configuration to the source DU 812.

The source DU 812, as shown by 821, is configured to transmit a RRC reconfiguration message comprising the DataCollectionConfig elements, to the UE 804.

The UE 804 can then be configured to confirm receipt of the RRC Reconfiguration to the network. This is shown by 823 where the UE sends a RRC reconfiguration complete message to the source DU 812, which in turn sends UL RRC message transfer to the CU 816 as shown by 825.

Having been configured to do so, the UE 804 is configured to start sending, as shown by 827, the measurement reports of the serving and candidate cells. The measurement reports can comprises, for example L1 beam measurements, L3 measurements or any suitable measured parameter.

When a target candidate cell with better radio link conditions than the serving cell the source DU triggers the cell switch. This is shown by the decision 829.

For example when the condition

L1-RSRP (target beam)>L1-RSRP (serving beam)+offset

is met for a defined time period (i.e., Time-to-Trigger (TTT) period), then the decision is made to enable the source DU 812 to send, as shown by 821, a MAC Control Element (MAC CE) to the UE 804 to trigger the cell switch.

In some embodiments the source DU 812 is further configured to also send an indicator to update the data collection configuration. For example the indicator can be used to inform the UE 804 that the UE is to proceed to collect data normally. The sending of this indicator is reflected as Alt 1 in FIG. 8b by 821.

In some embodiments, as reflected by Alt 2 in FIG. 8b by 823, the UE 804 can be configured evaluate the data collection condition itself. In some embodiments the UE may be configured to measure and store more than one data set (for example as indicated in the early examples the UE can comprise 3 data sets, one set for a normal ML model, another set for a HO specific model and one generated by combining both normal ML and HO specific model sets) with assistance information describing these groups.

As shown by 825 the UE can be configured to trigger an update to the model manager 802 to update the data collection process. Thus, for example, the UE is configured to generate a data collection update based on the data collection configuration update condition indicator from the source DU or evaluated by the UE as described above.

The training data collection update can, for example, be a suspend update or separate indication. In some embodiments the training data collection update indication can be generated at intervals (regular or irregular) rather than being triggered by the UE evaluation operation or the indicator.

The training data collection operations can then be updated based on the training data collection update indication received as shown by 827.

The handover operation can continue in that the UE 804 is configured to disconnect from the source DU 812 and performs a random access with the target DU 814, for example as shown by 729 in a random access procedure to the target node/DU 814.

In some embodiments the UE 804, as shown by 831, is further configured to evaluate a further update to data collection and based on this evaluation determine that the data collection is to be updated which is passed to the model manager as shown by 833. There can then be implemented an updating of the data collection procedure as shown by 835.

The training data collection update can, for example, be a resume update (where the earlier update indicator was a suspend update) or a return update (where the earlier update indicator was a separate update). In a similar manner to before in some embodiments the data collection update indication can be generated at intervals (regular or irregular) rather than being triggered by the UE evaluation operation shown by 831.

The UE 804 can furthermore be configured to indicate to the network that the handover to the target DU 814 was successful. Furthermore the UE 804 can be configured to indicate that it has data collection updates based on the earlier operations. This allows a target DU 814 to prepare for reception of the data groups in the future.

Thus, for example as shown by 837, the UE 804 sends to the target DU 814 a RRC reconfiguration complete message which comprises a Data update indication.

The target DU 814 can then send, as shown by 839, a handover success message to the CU 816.

Then the CU 816 and target DU 814 can be configured, as shown by 841, to implement a stopping of TX/RX to/from UE and start of data forwarding followed by user plane path switch.

This can be followed, as shown by 843, by the target DU 814 sending a data dispatch request to the UE 804. The data dispatch request can, in some embodiments, be configured to comprise a UL grant configuration.

This when received at the UE 804 cause a finalization of the data buffers as shown by 845, where the data buffers and any assistance information are assembled.

The data buffers with assistance information can then be passed from the model manager 802, to the UE 804, and then from the UE 804 to the target DU 814. This is shown respectively by 847 and 849. These data dispatches can employ the UL grants indicated by the target DU.

The target DU 814 and the CU 816 can then be configured to interpret the data sets and assistance information (and where determined process or combine the data sets with more advanced processing) as shown by 851. For example, in some situations, the processing can implement a combination of the normal ML model data set and the HO-specific data set where it is determined that an improved set can be generated by selecting a subset of samples from HO specific data set (for example from selected timestamps and ignoring others) creating a processed HO-specific data set for combining with normal ML model data set.

In some embodiments samples may be interpolated for the ignored/missing samples from the HO specific data set, Once the final data set is prepared it can be consumed for model training within the network (gNB, CU, DU, OAM, LMF, etc.) or forwarded to an external entity (e.g., NWDAF or Application Function outside the 3GPP network)—referred in FIG. 8c as TGT 820.

In some embodiments an optional timer is implemented, as shown by 853, at the target DU 814 before any further data collection information or assistance information is passed back to the UE and before any further data collection is implemented. As discussed above this is to prevent ping-pong operations or multiple switches in data collections from being implemented.

Furthermore in some embodiments the target DU 814 may then send a resume data collection message comprising updated assistance information as shown by 855. The resume data collection message to the UE can comprise updated assistance information indicating whether to combine data sets (where there are multiple data sets within the data collection (and in some embodiments, as described above, information for updated data collection configuration to operate in a target cell).

The UE can then be configured to process the data buffers based on the updated assistance information as shown by 857.

The model manager/UE can then continue the data collection and deliver data buffers based on any further network requests as shown by 859.

Although certain embodiments were described above by way of example with reference to certain example architectures for wireless networks, technologies and standards, embodiments may be applied to any other suitable forms of communication systems than those illustrated and described herein. In this example, some embodiments have been described in relation to a 5G network. It should be appreciated that other embodiments may be provided in any other suitable network.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions); and/or
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, an integrated circuit such as a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media. The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may comprise one or more of general-purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiments of this disclosure. However, various modifications and adaptations may become apparent to those skilled in the relevant arts in view of the foregoing description, when read in conjunction with the accompanying drawings and the appended claims. Indeed, there are further embodiments comprising a combination of one or more embodiments with any of the other embodiments previously discussed. The scope of protection sought for some embodiments of the disclosure is set out by the claims. The embodiments and features, if any, described in this specification that do not fall under the scope of the claims are to be interpreted as examples useful for understanding various embodiments of the disclosure. It should be noted that different claims with differing claim scope may be pursued in related applications such as divisional or continuation applications.

1.-25. (canceled)

26. An apparatus comprising:
a processor; and
a memory comprising computer-executable instructions that, when executed by a the processor, causes the processor to perform the following operations:
receiving a configuration from a first node, the configuration relating to collection of training data during a handover of the apparatus from the first node to a second node;
receiving a radio resource control reconfiguration message from the first node, wherein the radio resource control reconfiguration message comprises training data collection configuration for controlling the collection of the training data from measurements during the handover, the training data collection configuration generated based on an evaluation, performed at the first node, of network conditions between the apparatus and the first node;
controlling the collection of the training data from the measurements during the handover based on the configuration by:
suspending a normal collection of a first portion of the training data following an initiation of the handover;
switching the collection of a second portion of the training data to a separate training data buffer following the initiation of the handover;
separating the collection of a third portion of the training data into a normal data buffer and a handover training data buffer following the initiation of the handover;
resuming the normal collection of the first portion of the training data following a successful handover;
returning the collection of the second portion of the training data and the collection of the third portion of the training data to an earlier training data buffer following the successful handover;
evaluate received configuration conditions; and
control the collection of the training data from the measurements based on the evaluation;
informing the second node a state of the collection of the training data from the measurements following a completion of the handover by informing the second node that the collection of the training data from the measurements comprises at least two separate training data buffers and information for assisting the processing of the at least two separate training data buffers; and
transferring any collection of the training data from the measurements to the second node following the completion of the handover.

27. The apparatus of claim 26, wherein the computer-executable instructions, when executed by the processor, further cause the processor to perform the following operations: sending a measurement report to the first node, wherein the measurement report comprises a collection of training data update early indication.

28. The apparatus of claim 27, wherein the computer-executable instructions, when executed by the processor, further cause the processor to perform the following operations: sending a radio resource control reconfiguration complete message to the first node, wherein the radio resource control reconfiguration complete message comprises a collection of training data update indication.

29. The apparatus of claim 28, wherein the computer-executable instructions, when executed by the processor, further cause the processor to perform the following operations: receiving a training data dispatch request from the second node, wherein the training data dispatch request comprises an uplink grant configuration.

30. The apparatus of claim 29, wherein transferring any collection of the training data from the measurements to the second node following the completion of the handover comprises sending a training data dispatch using the uplink grant configuration.

31. The apparatus of claim 30, wherein the training data dispatch comprising at least one collection of training data buffer with assistance information.

32. The apparatus of claim 31, wherein the apparatus is a user equipment, and wherein the first node is a source node and the second node is a target node for the handover.

33. A system comprising:
an apparatus;
a processor; and
a memory comprising computer-executable instructions that, when executed by a the processor, causes the processor to perform the following operations:
receiving a configuration from a first node, the configuration relating to collection of training data during a handover of the apparatus from the first node to a second node;
receiving a radio resource control reconfiguration message from the first node, wherein the radio resource control reconfiguration message comprises training data collection configuration for controlling the collection of the training data from measurements during the handover, the training data collection configuration generated based on an evaluation, performed at the first node, of network conditions between the apparatus and the first node;
controlling the collection of the training data from the measurements during the handover based on the configuration by:
suspending a normal collection of a first portion of the training data following an initiation of the handover;
switching the collection of a second portion of the training data to a separate training data buffer following the initiation of the handover;
separating the collection of a third portion of the training data into a normal data buffer and a handover training data buffer following the initiation of the handover;
resuming the normal collection of the first portion of the training data following a successful handover;
returning the collection of the second portion of the training data and the collection of the third portion of the training data to an earlier training data buffer following the successful handover;
evaluate received configuration conditions; and
control the collection of the training data from the measurements based on the evaluation;
informing the second node a state of the collection of the training data from the measurements following a completion of the handover by informing the second node that the collection of the training data from the measurements comprises at least two separate training data buffers and information for assisting the processing of the at least two separate training data buffers; and
transferring any collection of the training data from the measurements to the second node following the completion of the handover.

34. The system of claim 33, wherein the computer-executable instructions, when executed by the processor, further cause the processor to perform the following operations: sending a measurement report to the first node, wherein the measurement report comprises a collection of training data update early indication.

35. The system of claim 34, wherein the computer-executable instructions, when executed by the processor, further cause the processor to perform the following operations: sending a radio resource control reconfiguration complete message to the first node, wherein the radio resource control reconfiguration complete message comprises a collection of training data update indication.

36. The system of claim 35, wherein the computer-executable instructions, when executed by the processor, further cause the processor to perform the following operations: receiving a training data dispatch request from the second node, wherein the training data dispatch request comprises an uplink grant configuration.

37. The system of claim 36, wherein transferring any collection of the training data from the measurements to the second node following the completion of the handover comprises sending a training data dispatch using the uplink grant configuration.

38. The system of claim 37, wherein the training data dispatch comprising at least one collection of training data buffer with assistance information.

39. The system of claim 38, wherein the apparatus is a user equipment, and wherein the first node is a source node and the second node is a target node for the handover.

40. A method comprising:
receiving a configuration from a first node, the configuration relating to collection of training data during a handover of the apparatus from the first node to a second node;
receiving a radio resource control reconfiguration message from the first node, wherein the radio resource control reconfiguration message comprises training data collection configuration for controlling the collection of the training data from measurements during the handover, the training data collection configuration generated based on an evaluation, performed at the first node, of network conditions between the apparatus and the first node;
controlling the collection of the training data from the measurements during the handover based on the configuration by:
suspending a normal collection of a first portion of the training data following an initiation of the handover;
switching the collection of a second portion of the training data to a separate training data buffer following the initiation of the handover;
separating the collection of a third portion of the training data into a normal data buffer and a handover training data buffer following the initiation of the handover;
resuming the normal collection of the first portion of the training data following a successful handover;
returning the collection of the second portion of the training data and the collection of the third portion of the training data to an earlier training data buffer following the successful handover;
evaluate received configuration conditions; and
control the collection of the training data from the measurements based on the evaluation;
informing the second node a state of the collection of the training data from the measurements following a completion of the handover by informing the second node that the collection of the training data from the measurements comprises at least two separate training data buffers and information for assisting the processing of the at least two separate training data buffers; and
transferring any collection of the training data from the measurements to the second node following the completion of the handover.

41. The method of claim 40, further comprising sending a measurement report to the first node, wherein the measurement report comprises a collection of training data update early indication.

42. The method of claim 41, further comprising sending a radio resource control reconfiguration complete message to the first node, wherein the radio resource control reconfiguration complete message comprises a collection of training data update indication.

43. The method of claim 42, further comprising receiving a training data dispatch request from the second node, wherein the training data dispatch request comprises an uplink grant configuration.

44. The method of claim 43, wherein transferring any collection of the training data from the measurements to the second node following the completion of the handover comprises sending a training data dispatch using the uplink grant configuration.

45. The method of claim 44, wherein the training data dispatch comprising at least one collection of training data buffer with assistance information.
